(19) United States
(12) Patent Application Publication
(10) Pub. No.: US 2017/0138335 A1
(43) Pub. Date: May 18, 2017

(54) HYDROSTATIC RADIAL PISTON MACHINE

(71) Applicant: Moog GmbH, Böblingen (DE)

(72) Inventors: Dirk Becher, Nufringen (DE); Tino Kentschke, Weil der Stadt (DE); Achim Helbig, Stuttgart (DE)

(73) Assignee: Moog GmbH, Boblingen (DE)

(21) Appl. No.: 15/127,673

(22) PCT Filed: Mar. 16, 2015
(86) PCT No.: PCT/EP2015/055461

§ 371 Date: Sep. 20, 2016

(30) Foreign Application Priority Data
Mar. 21, 2014 (EP) 14161072.5

(51) Int. Cl. F03C 1/36; F03C 1/40; F15B 11/10; F04B 1/047; F04B 1/06; F03C 1/047; F04B 1/04

(52) U.S. Cl. CPC F03C 1/0438; F03C 1/047; F03C 1/045; F04B 1/0456; F04B 1/047; F04B 1/063; F15B 11/10; F15B 2211/7053

(57) ABSTRACT

The invention relates to a hydrostatic radial piston motor, in particular a hydrostatic radial piston motor for actuating a differential cylinder. According to the invention, the hydrostatic motor in radial piston configuration comprises a control stud in a housing, the hydrostatic motor having three hydraulic working connections. The first working connection can be connected to the piston-end of a differential cylinder, while the second working connection can be connected to the rod-end of the differential cylinder. Finally, the third working connection can be connected to a tank. Owing to this arrangement, the differential cylinder can be directly operated with the aid of a single hydrostatic motor, with it being possible to forgo interposing proportional or control valves.

The invention relates to a hydrostatic radial piston motor, in particular a hydrostatic radial piston motor for actuating a differential cylinder.

Generic hydrostatic radial piston motors are used in many types of industrial applications. Generic hydrostatic radial piston motors are thus found in machines for spray and pressure casting processes, systems for forming processes, such as presses and rolling mills, as well as in the general construction of hydraulic power systems.

In a generic radial piston motor, the drive torque of the shaft is transmitted to a radial piston cylinder block mounted on a control stud. Pistons arranged radially in the radial piston cylinder block are supported on thrust rings via slide shoes in a thrust ring. The slide shoes can be hydrostatically relieved in a suitable manner. Piston and slide shoe are connected to one another via a joint and secured by a ring. The slide shoes are guided by two overlapping rings and pressed against the thrust ring during operation by centrifugal force and oil pressure. When the radial piston cylinder block rotates, the pistons, as a result of the eccentric position of the thrust ring, exert a stroke movement equal to two times the value of the eccentricity. The eccentricity can be changed by two setting pistons lying opposite one another in the pump housing. The oil flow is routed into and out of the housing and control stud via channels. It is controlled by means of suction and pressure windows in the control stud. The thrust ring position (flow rate) as well as the system pressure can thus be controlled by means of a control unit. If a differential cylinder is to be actuated by means of a hydrostatic radial piston motor, proportional or control valves are usually interposed. Differential cylinders comprise two working spaces, each with its own working connection, a first working connection leading to the working space on the piston-end and a second working connection leading to the working space on the rod-end of the differential cylinder. The volume flow of the hydraulic fluid supplied by the hydrostatic radial piston motor can be routed to the particular working connection and thereby to the particular working space via the valves.

It is possible to actuate a differential cylinder via a hydrostatic radial piston motor without interposing proportional or control valves by driving the different travel directions of the piston rods via two hydrostatic displacement units. The displacement units can be provided on a drive shaft, the drive shaft generally being connected to an electric motor which is typically operated at variable rotational speed and rotational direction. Alternatively, the rotational speed of the electric motor can be constant, and two displacement units having variable delivery volumes can be operated on the drive shaft. The disadvantage of this, however, is that it requires two displacement units and is thus expensive. Another disadvantage is that this type of unit is of large construction especially in the axial dimension and requires accordingly large installation space even if the two hydrostatic displacement units are provided on one drive shaft.

The object of the invention is to provide a device with which a differential cylinder can, with the aid of a single hydrostatic motor, be operated directly, in particular without proportional or control valves being interposed, the device being cost-efficient to produce and requiring only a small amount of installation space. The invention additionally seeks to provide a hydraulic actuator as a corresponding system.

This objective is achieved according to the invention by a hydrostatic motor having the features of the independent Claim 1. Advantageous refinements of the method are found in the subordinate claims 2 to 12. The objective is further achieved by a hydraulic actuator according to Claim 14. One advantageous embodiment of the hydraulic actuator is described in Claim 15.

According to the invention, the hydrostatic motor comprises a displacement unit in radial piston configuration, the displacement unit being actuated by a drive motor and the hydrostatic motor additionally featuring a housing in which a control stud is arranged, the hydrostatic motor comprising at least three hydraulic working connections. The first working connection can be connected to the working connection of the piston-end of a differential cylinder, while the second working connection can be connected to the rod-end of the differential cylinder. Finally, the third working connection can be connected to a tank. Owing to this arrangement, the differential cylinder can be directly operated with the aid of a single hydrostatic motor, it being possible to forgo interposing proportional or control valves. The device can be produced cost-efficiently and requires only a small amount of installation space. The drive motor can be an electric motor in particular.

One advantageous embodiment of the hydrostatic motor is characterized in that the control stud comprises a first work-side control window connected to a first working connection A, a second work-side control window connected to a second working connection B and a third control window connected to a third working connection T. The control stud features, in addition to the work-side, i.e. pressure-side control windows, suction side control windows. The control stud can feature reversing notches at all control windows.

It has proven to be especially advantageous if the second work-side control window has a smaller cross section than the first work-side control window. This arrangement allows the asymmetry of the effective piston areas of the differential cylinder to be balanced out.

In another advantageous embodiment, the third work-side control window likewise has a smaller cross section than the first work-side control window, thereby allowing only a portion of the hydraulic fluid conveyed out of or into the piston-side to be discharged into the tank or resuctioned from the same, respectively.

It has additionally proven to be advantageous if the third work-side control window is connected to a pressurized tank. The hydrostatic motor can thus be used in a closed hydraulic system in a simple manner.

To avoid undesired operating states during the extension and retraction of the piston rod of the differential cylinder, the ratio of the first and second work-side control window can be adjusted to match the area ratio of the effective areas of the piston of the piston-end and rod-end of the differential cylinder. The area ratio of the effective areas of the piston of piston-end and rod-end of the differential cylinder can be determined by configuring the control window in the control stud accordingly.

The area ratio of the effective areas of the piston between piston-end and rod-end of the differential cylinder corresponds to the ratio of the working space volume between the piston-end and rod-end of the differential cylinder. A volume flow balance can thereby be established at the displacement unit, in which the volume flow at the working connection to the piston-end working space of the differential cylinder equals the total of the volume flows to the rod-end working space of the differential cylinder and to the tank. At the same time, the volume flow into a working space of the differential cylinder equals the product of the piston rod speed of the differential cylinder and the particular effective piston area of the differential cylinder. The individual volume flows at the working connections of the displacement unit can thus be computed, wherein these volume flows equal those in the particular working spaces of the differential cylinder and the tank, respectively.

The volume flow at the working connection to the piston-end working space of the differential cylinder equals the rotational speed of the displacement unit multiplied by the volume geometrically determined in the displacement unit at the first work-side control window and thus the product of the rotational speed of the displacement unit multiplied by the square of the stroke piston diameter, the eccentricity, the number of pistons and ½π as a constant.

The volume flow at the working connection to the rod-end working space of the differential cylinder equals the rotational speed of the displacement unit multiplied by the volume geometrically determined in the displacement unit at the second work-side control window and thus the product of the rotational speed of the displacement unit multiplied by the square of the stroke piston diameter, the eccentricity, the number of pistons and ½π as a constant divided by the ratio of the effective piston areas of the differential cylinder, i.e. the product of the rotational speed of the displacement unit and the volume flow at the working connection to the piston-end working space of the differential cylinder divided by the ratio of the effective piston areas of the differential cylinder.

The volume flow at the working connection to the tank is equal to the rotational speed of the displacement unit multiplied by the volume of the piston-end working space of the differential cylinder and the difference between 1 and the reciprocal of the ratio of the effective piston areas of the differential cylinder.

Intake and outlet direction of the piston rod as well as the differential cylinder are controlled by the rotational direction of the motor. For example, the motor running counterclockwise corresponds to the piston rod extending, while the motor running clockwise corresponds to the retraction thereof.

It has additionally proven to be advantageous if the control stud is fixedly connected to the housing.

Furthermore, the housing likewise comprises in an additional advantageous embodiment three working connections which create the connection to the two working connections of the differential cylinder and to the tank.

In another advantageous embodiment, the second control window Port B is formed by two sub-control windows Port B1 and Port B2, the sub-control windows being connected to the working connection B and, the third control window, when viewed in the circumferential direction of the control stud, lying between sub-control windows Port B1 and Port B2. In an alternative embodiment, the third control window Port T is formed by two sub-control windows Port T1 and Port T2, the sub-control windows being connected to the working connection T and, when viewed in the circumferential direction of the control stud, the second control window Port B being between the sub-control windows Port T1 and Port T2.

In another advantageous embodiment, the hydrostatic motor comprises an additional hydraulic connection via which any occurring leakage oil can be transported away.

The hydrostatic motor can be a fixed displacement pump in which the displacement volume is constant. Alternatively, the hydrostatic motor can also have an adjustment device allowing adjustment of its displacement volume.

A hydraulic actuator according to the invention for actuating a differential cylinder comprises the differential cylinder itself, a tank and a hydrostatic motor according to the invention. The first working connection A of the hydrostatic motor is connected to the working connection of the piston-end of the differential cylinder, the second working connection B of the hydrostatic motor to the working connection of the rod-end of the differential cylinder, while the third working connection T of the hydrostatic motor is connected to the tank.

In an advantageous embodiment of the hydraulic actuator, the tank has a check valve via which it is connected to the first working connection A of the hydrostatic motor and/or the second working connection B of the hydrostatic motor.

Additional advantages, features and expedient refinements of the invention are contained in the subordinate claims and the following description of preferred exemplary embodiments on the basis of the drawings.

The drawings show:

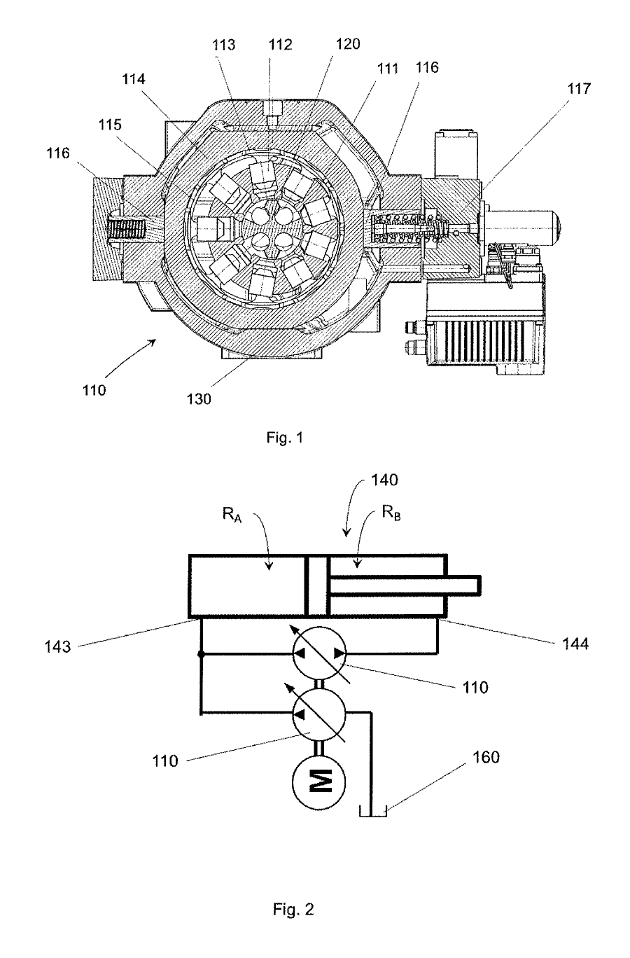

FIG. 1 Radial piston pump (prior art)

FIG. 2 Conceptual diagram of a differential cylinder with two hydrostatic displacement units (prior art)

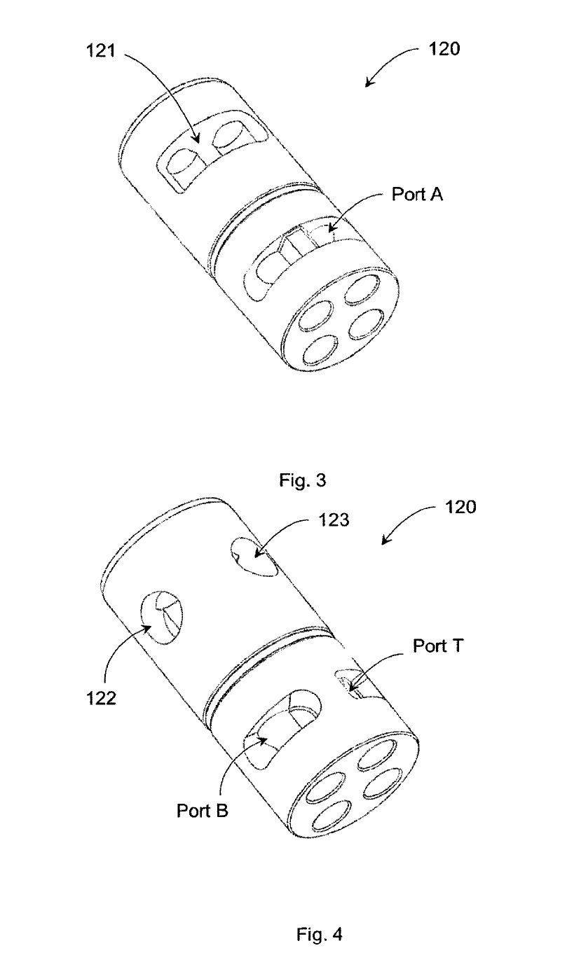

FIG. 3 A three-dimensional view of a control stud from a first perspective

FIG. 4 A three-dimensional view of a control stud from a second perspective

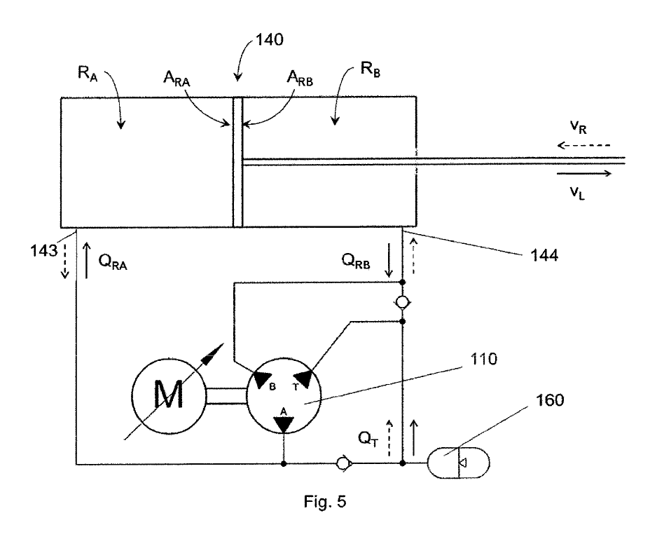

FIG. 5 Principle schematic diagram of a hydrostatic radial piston motor according to the invention actuating a differential cylinder

FIG. 1 shows a sectional view of a displacement unit 110 in the form of a radial piston pump as is known from the prior art. The drive torque is transmitted free of lateral force from a shaft via a clutch to the radial piston cylinder block 111 which is mounted on the control stud 120. The stroke pistons 112 radially arranged in the radial piston cylinder block 111 rest in the thrust ring 114 on hydrostatically relieved slide shoes 113. Piston 112 and slide shoe 113 are connected to one another via a ball joint and secured by a ring. The slide shoes are guided in the thrust ring 114 by two overlapping rings 115 and pressed against the thrust ring 114 during operation by centrifugal force and oil pressure. When the radial piston cylinder block 111 rotates, the pistons 112, as a result of the eccentric position of the thrust ring 114, exert a stroke movement equal to two times the value of the eccentricity. The eccentricity is changed by two setting pistons 116 lying opposite one another in the pump housing 130. The oil flow is routed into and out of the housing 130 and control stud 120 via channels. It is controlled by means of suction and pressure windows (ports) in the control stud 120. A control unit 117 controls the position of the thrust ring and thereby the flow rate as well as system pressure.

FIG. 2 shows a conceptual diagram of a differential cylinder 140 from the prior art which is actuated via two hydrostatic displacement units 110. Both hydrostatic displacement units 110 are variable displacement pumps arranged on a motor shaft which is driven by a motor M. While the motor M can be an electric motor, the use of other motors, such as internal combustion engines for example, is likewise possible. The differential cylinder 140 comprises a piston-end working space R_{A} and a rod-end working space R_{B} which can be charged with hydraulic fluid via a working connection 143 on the piston-end of the differential cylinder and via a working connection 144 on the rod-side of the differential cylinder, respectively. The embodiment shown is provided with a second displacement unit 110 for balancing the hydraulic volume when the differential cylinder 140 is moved, said displacement unit being able, depending on the direction of movement of the differential cylinder 140, to deliver hydraulic fluid from a tank 160 to the working space R_{A} or pump it out of working space R_{A} and into the tank 160.

FIG. 3 shows a three-dimensional view of a control stud 120 from a first perspective. From this perspective the first control window Port A is visible. The first control window Port A is connected to a first connection window 121 via a borehole running inside the control stud 120. The first connection window 121 connects the first control window Port A to the working connection A of the hydrostatic motor 100.

FIG. 4 shows a three-dimensional view of the control stud 120 from a second perspective rotated roughly 180° around the rotational axis from the view shown in FIG. 3, in which the second control window Port B and the third control window Port T are visible. The second control window Port B is connected to a second connection window 122 via a borehole running inside the control stud 120. The second connection window connects the second control window Port B to the working connection B of the hydrostatic motor 100. The third control window Port T is connected to a third connection window 123 via a borehole running inside the control stud 120. The third connection window 123 connects the third control window Port T to the working connection T of the hydrostatic motor 100.

The first control window Port A is connected to the piston-end R_{A} of the differential cylinder 140, while the second control window Port B is connected to the rod-end R_{B} of the differential cylinder 140. The third control window Port T is connected to a tank 160. Owing to this arrangement, the differential cylinder 140 can be driven directly with the aid of a single hydrostatic motor 100 without proportional or control valves having to be interposed.

The second control window Port B has a smaller cross section than the first control window Port A. The ratio between the first control window Port A and the second control window Port B thus equals the ratio of effective piston areas in the piston-end working space R_{A} and in the rod-end working space R_{B} of the differential cylinder 140. This arrangement allows the asymmetry of the effective piston areas of the differential cylinder to be balanced out.

The third control window Port T likewise has a smaller cross section than the first control window Port A, thereby allowing only a portion of the hydraulic fluid conveyed out of or into the piston-side to be discharged into the tank or resiphoned from the same.

The control stud features, in addition to the work-side, i.e. pressure-side control windows, suction side control windows. The control stud can feature reversing notches at all control windows.

The area ratio φ of the effective areas A_{RA} and A_{RB} of the piston from piston-end R_{A} and rod-end R_{B} of the differential cylinder 140 is determined by a kidney-shaped design of the control windows Port A, Port B, Port T in the control stud 120.

FIG. 5 shows a principle schematic diagram of a hydrostatic radial piston motor 100 according to the invention actuating a differential cylinder 140. The hydrostatic radial piston motor comprises a motor M of variable rotational direction and rotational speed and a radial piston pump 110 driven thereby. The differential cylinder 140 comprises a piston with a piston rod as well as the corresponding working spaces R_{A}, R_{B}. The effective piston area A_{RB} on the rod-end R_{B} is reduced in relation to the effective piston area A_{RA} on the piston-end R_{A} by the piston rod. The working spaces R_{A} and R_{B} are connected via working connections 143, 144 to the working connections A,B of the radial piston pump 110 such that the piston rod extends with the motor M running counterclockwise, while the motor running clockwise causes the piston rod to retract into the differential cylinder 140, the retraction direction being indicated by a dashed arrow and the extension direction by a solid arrow. The arrows at the control lines denote the volume flows Q_{A} into and out of the piston-end working space R_{A} of the differential cylinder 140, Q_{B} into and out of the rod-end working space R_{B} of the differential cylinder 140 and out of the tank Q_{T}. The solid arrows denote the flow direction of the hydraulic fluid for the extension movement of the piston rod from the differential cylinder 140, while the dashed arrow denotes the flow direction of the hydraulic fluid for the retraction movement of the piston rod of the differential cylinder 140. The piston rod extends from the differential cylinder 140 at the speed V_{L} and retracts into the differential cylinder 140 at the speed V_{R}.

The area ratio φ of the effective areas A_{RA}, A_{RB} of the piston between piston-end R_{A} and rod-end R_{B} of the differential cylinder 140 correspond to the ratio of the working space volume V_{A}, V_{B} between the piston-end R_{A} and rod-end R_{B} of the differential cylinder 140: φ=A_{RA}/A_{RB}=V_{A}/V_{B}. A volume flow balance can thereby be established at the displacement unit 110, in which the volume flow Q_{A} at the working connection A to the piston-end working space R_{A} of the differential cylinder 140 equals the total of the volume flows Q_{B}, Q_{T} to the rod-end working space R_{B} of the differential cylinder 140 and to the pressurized tank 160. At the same time, the volume flow Q_{RA}, Q_{RB} into a working space R_{A}, R_{B} the differential cylinder 140 equals the product of the piston rod speed v of the differential cylinder 140 and the particular effective piston area A_{RA}, A_{RB} of the differential cylinder 140: Q_{A}=Q_{B}+Q_{T}=v*A_{RA}=v*A_{RB}+Q_{T}. The individual volume flows Q_{A}, Q_{B}, Q_{T} at the working connections A, B, T of the radial piston pump 110 can thus be computed, where these volume flows Q_{A}, Q_{B}, Q_{T} equal those into the particular working spaces R_{A}, R_{B} of the differential cylinder and into the tank 160, respectively.

The volume flow Q_{A} at the working connection A to the piston-end working space R_{A} of the differential cylinder 140 equals the rotational speed of the radial piston pump 110 multiplied by the volume V_{A} geometrically determined in the displacement unit at the first work-side control window Port A and thus the product of the rotational speed n of the radial piston pump 110 multiplied by the square of the stroke piston diameter D, the eccentricity e, the number of pistons z and ½π as a constant:

Q_{A}=n*V_{A}=n*π/2*D²e*z.

The volume flow Q_{B} at the working connection B to the rod-end working space R_{B} of the differential cylinder 140 equals the rotational speed n of the radial piston pump 110 multiplied by the volume V_{B} geometrically determined in the displacement unit at the second work-side control window Port B and, thus, the product of the rotational speed n of the radial piston pump 110 multiplied by the square of the stroke piston diameter D, the eccentricity e, the number z of pistons and ½π as a constant divided by the ratio of the effective piston areas A_{RA}, A_{RB} of the differential cylinder 140, i.e. the product of the rotational speed n of the radial piston pump 110 and the volume flow Q_{RA} at the working connection 143 to the piston-end working space R_{A} of the differential cylinder 140 divided by the ratio φ of the effective piston areas A_{RA}, A_{RB} of the differential cylinder 140:

Q_{B}=n*V_{B}=n*π/2*D^{2*}e*z/φ=n*V_{A}/φ

The volume flow QT at the working connection T to the tank 160 is equal to the rotational speed n of the radial piston pump 110 multiplied by the volume VA of the piston-end working space RA of the differential cylinder 140 and the difference between 1 and the reciprocal of the ratio φ of the effective piston areas A_{RA}, A_{RB} of the differential cylinder 140:

QT=n*VA*(1−1/φ)

In the example illustrated in FIG. 5, the delivery volume of the radial piston pump at an area ratio φ of the effective area A_{RA} of the piston-end R_{A} to the effective area A_{RB} of the rod-side R_{B} of 1.5:1 is 18 cm³ at working connection B, 12 cm³ at working connection B and at working connection T 6 cm³ per revolution.

From a manufacturing point of view, area ratios φ ranging from 1.4:1 to 3.5:1 have proven to be advantageous.

The embodiments shown here represent only examples of the present invention, and are therefore not to be understood as limiting. Alternative embodiments considered by the person skilled in the art are similarly encompassed by the protective scope of the present invention.

### LIST OF REFERENCE NUMBERS

100 hydrostatic motor
110 displacement unit
111 radial piston cylinder block
112 piston
113 slide shoes
114 thrust ring
115 ring
116 setting piston
117 control unit
120 control stud
121 first connection window
122 second connection window
123 third connection window
130 housing
140 differential cylinder
143 piston-end working connection of the differential cylinder
144 rod-end working connection of the differential cylinder
160 tank
A displacement unit working connection to the piston-end working space of the differential cylinder
A_{RA} piston-end piston area
A_{RB} rod-end piston area
B displacement unit working connection to the rod-end working space of the differential cylinder
D diameter of a piston
e eccentricity
T displacement unit working connection to the tank
M motor
n displacement unit rotational speed
Port A first control window
Port B second control window
Port B1 first sub-control window of the second control window
Port B2 second sub-control window of the second control window
Port T third control window
Port T1 first sub-control window of the third control window
Port T2 second sub-control window of the third control window
Q_{RA} volume flow into the piston-end working space of the differential cylinder
Q_{RB} volume flow into the rod-end working space of the differential cylinder
Q_{T} volume flow out of the tank
R_{A} piston-end working space of the differential cylinder, piston end
R_{B} rod-end working space of the differential cylinder, rod end
T tank
V speed of the differential cylinder piston rod
VL speed of the differential cylinder piston rod with motor running counterclockwise
vR speed of the differential cylinder piston rod with motor running clockwise
V_{A} volume geometrically determined in the displacement unit at the first control window Port A
V_{B} volume geometrically determined in the displacement unit at the second control window Port B, number of pistons z
φ ratio of effective piston surfaces of the differential cylinder
π pi

1. Hydrostatic motor (100) in radial piston configuration comprising a displacement unit (110), the displacement unit (110) being actuated by a drive motor (M) and having a housing (130) in which a control stud (120) is arranged,
characterized in that the hydrostatic motor (100) has at least three hydraulic working connections.

2. Hydrostatic motor (100) according to claim 1,
characterized in that
the control stud (120) has a first control window (Port A) connected to a first working connection (A), a second control window (Port B) connected to a second working connection (B), and a third control window (Port T) connected to a third working connection (T).

3. Hydrostatic motor (100) according to any of the preceding claims,
characterized in that
the second control window (Port B) has a smaller cross section than the first control window (Port A).

4. Hydrostatic motor (100) according to any of the preceding claims,
characterized in that
the third control window (Port T) has a smaller cross section than the first control window (Port A).

5. Hydrostatic motor (100) according to any of the preceding claims,
characterized in that
the third control window (Port T) is connected to a pressurized tank (T).

6. Hydrostatic motor (100) according to any of the preceding claims,
characterized in that
the ratio between the first and second control windows (Port A, Port B) is adjusted to match the area ratio of the effective areas of the piston (143) of piston end (R_{A}) and rod end (R_{B}) of the differential cylinder (140).

7. Hydrostatic motor (100) according to any of the preceding claims,
characterized in that
the control stud (120) is fixedly connected to the housing (130).

8. Hydrostatic motor (100) according to any of the preceding claims,
characterized in that
the second control window (Port B) is formed by two sub-control windows (Port B1, Port B2), the sub-control windows being connected to the working connection (B), and, when viewed in the circumferential direction of the control stud (120), the third control window (Port T) lying between the sub-control windows (Port B1, Port B2).

9. Hydrostatic motor (100) according to any of claims 1 to 7,
characterized in that
the third control window (Port T) is formed by two sub-control windows (Port T1, Port T2), the sub-control windows being connected to the working connection (T), and, when viewed in the circumferential direction of the control stud (120), the second control window (Port B) lying between the sub-control windows (Port T1, Port T2).

10. Hydrostatic motor (100) according to any of the preceding claims,
characterized in that
the hydrostatic motor (100) comprises an additional hydraulic port, via which any appearing leakage oil can be transported away.

11. Hydrostatic motor (100) according to any of the preceding claims,
characterized in that
the displacement volume of the hydrostatic motor (100) is constant.

12. Hydrostatic motor (100) according to any of claims 1 to 10,
characterized in that
the hydrostatic motor (100) comprises an adjustment device that can be adjusted via its displacement volume.

13. Hydraulic actuator for actuating a differential cylinder (140), including the differential cylinder (140), a tank (160) and a hydrostatic motor (100) according to any of the preceding claims,
characterized in that
the first working connection (A) of the hydrostatic motor (100) is connected to the working connection (143) of the piston-end of the differential cylinder (140), the second working connection (B) of the hydrostatic motor (100) to the working connection (144) of the rod-end of the differential cylinder (140), while the third working connection (T) of the hydrostatic motor (100) is connected to the tank (160).

14. Hydraulic actuator according to claim 13,
characterized in that
the tank (160) has a check valve via which it is connected to the first working connection (A) of the hydrostatic motor (100) and/or the second working connection (B) of the hydrostatic motor (100).
